(19) United States
(12) Patent Application Publication
(10) Pub. No.: US 2022/0404779 A1
(43) Pub. Date: Dec. 22, 2022

(54) METHOD AND DEVICE FOR GENERAL LEARNING BY COMPUTER, AND NON-TRANSITORY COMPUTER READABLE STORAGE MEDIUM

(71) Applicant: Chengdu Cyberkey Technologies Co., Ltd., Sichuan (CN)

(72) Inventor: Chuyu XIONG, Sichuan (CN)

(73) Assignee: Chengdu Cyberkey Technologies Co., Ltd., Sichuan (CN)

(21) Appl. No.: 17/623,667

(22) PCT Filed: Jun. 12, 2020
(86) PCT No.: PCT/CN2020/095829

§ 371 Date: Aug. 24, 2022

(30) Foreign Application Priority Data
Jul. 3, 2019 (CN) 201910593937.7

(51) Int. Cl. G05B 13/02

(52) U.S. Cl. CPC G05B 13/0265

(57) ABSTRACT

A method and device for learning by a computer, and a non-transitory computer readable storage medium, relating to the technical field of computers. The method includes: transforming data to be processed into a vector to be processed (110); determining a corresponding target processing node (120); and processing said vector (130).

### CROSS-REFERENCE TO RELATED APPLICATIONS

This application is a U.S. National Stage Application of PCT/CN2020/095829, filed on Jun. 12, 2020, which claims priority benefit to Chinese patent application No. 201910593937.7 filed on Jul. 3, 2019, which are hereby incorporated by reference in their entireties into the present application.

### TECHNICAL FIELD

The present disclosure relates to the field of computer technology, and in particular, to a method and apparatus for computer learning, and a non-transitory computer-readable storage medium.

### BACKGROUND

With a clear understanding of computing theories, relatively complete theories have been established and put into industrial practice for decades. In such a framework, a task that can be calculated by a machine can be equivalent to a program. In fact, what can be achieved by computer development over the past 80 years is that: if it is desired to perform a certain task by a machine, it can be done through designing a model, finding an algorithm suitable for the model, writing a program to implement the algorithm, and finally executing the program by appropriate hardware.

Such computer development faces a bottleneck. First of all, developing programs in this way requires huge human and material resources. Naturally a question arises—is there a better way? Second, for many problems, more and more problems in fact, it is difficult to obtain effective programs in this way. This has been proven repetitively by past history.

A notable example is the Go program. In 1997, the Deep Blue program, as an artificially programmed program, defeated the best human players at chess. After that, attention is naturally turned to the Go program, which is more difficult. However, in the field of Go, for almost two decades, artificially programmed programs progressed slowly, and the fact is that the playing ability of these programs was still far below the ability of human players. However, after the introduction of machine learning technologies such as deep learning, the ability of the Go program has made great progress. Finally, AlphaGo has defeated the best human players. Through machine learning, rather than manual programming, the Go program has reached unprecedented levels.

That is to say, to give computers the ability to do the work expected, it can no longer rely solely on human programming. Instead, machine learning can be adopted to change the behavior of a machine, giving the machine the ability expected. This was the way of development of deep learning in the last decade, which has brought great success. However, machine learning to date, even with great success like deep learning, is still not all-purpose learning.

Machine learning enables computers to simulate or implement human learning behaviors, to acquire new knowledge or skills, and to restructure existing knowledge to continuously improve their performance. Therefore, machine learning is the core of artificial intelligence and the fundamental way to make computers intelligent. Machine learning can be applied in various fields of artificial intelligence, such as object recognition, image processing, automatic control, etc.

In the related art, a parameter system is set up artificially and parameters are adjusted to adapt to actual data.

### SUMMARY

According to some embodiments of the present disclosure, a method for computer learning is provided, comprising: converting data to be processed into a vector to be processed; from a set of processing nodes of a learning model, determining a target processing node corresponding to the vector to be processed; using the target processing node to process the vector to be processed to obtain a processing result of the data to be processed.

In some embodiments, the vector to be processed is a Boolean vector of which components are Boolean values, the set of processing nodes is a set of Boolean functions, and the target processing node is a target Boolean function.

In some embodiments, the learning model is trained by: creating at least one candidate processing node using the at least one processing node in the set of processing nodes according to at least one training data pair, each of the at least one training data pair comprising an input vector and an expected output value, wherein a difference between a processing result of processing the input vector by each of the at least one candidate processing node and the expected output value is less than a threshold; according to a restriction function, from the at least one candidate processing node, determining a target processing node corresponding to the input vector.

In some embodiments, creating at least one candidate processing node using the at least one processing node in the set of processing nodes comprises: performing operations on the at least one processing node to create the at least one candidate processing node.

In some embodiments, the learning model is trained by: creating at least one candidate Boolean function using the at least one Boolean function in the set of Boolean functions according to at least one training data pair, each of at least one training data pair comprising an input Boolean vector and an expected output value, wherein a difference between a processing result of processing the input Boolean vector by each of the at least one candidate processing node and the expected output value is less than a threshold; according to a restriction function, from the at least one candidate Boolean function, determining a target Boolean function corresponding to the input Boolean vector.

In some embodiments, creating at least one candidate Boolean function using the at least one Boolean function in the set of Boolean functions comprises: performing at least one logical operation on variable assignment conditions of the at least one Boolean function to form a new variable assignment condition, the logical operation comprising at least one of a first logical operation that is a logical operation between different variable assignment conditions, or a second logical operation that is a logical operation between components corresponding to Boolean vectors in different variable assignment conditions; creating the at least one candidate Boolean function according to the new variable assignment condition.

In some embodiments, the restriction function is determined according to the number of logical operations corresponding to the candidate Boolean function; determining a target Boolean function corresponding to the input Boolean vector from the at least one candidate Boolean function comprises: determining a candidate Boolean function having the minimum number of logical operations as the target Boolean function corresponding to the input Boolean vector.

In some embodiments, there are at least one training data pair comprises a plurality of training data pairs, and the difference between the processing result of processing each input vector by the candidate processing node and its corresponding expected output value is less than a corresponding threshold.

In some embodiments, the method for computer learning further comprises: adding the at least one candidate processing node to the set of processing nodes.

In some embodiments, the Boolean function in the set of Boolean functions is created by: according to the input Boolean vector in a training data pair, determining a variable assignment condition of the Boolean function; according to the expected output value in the training data pair, determining an evaluation value of the Boolean function.

In some embodiments, the learning model has a plurality of sets of Boolean functions; from the plurality of sets of Boolean functions, determining target Boolean functions corresponding to the Boolean vector, respectively; obtaining Boolean values through processing the Boolean vector using the target Boolean functions, respectively; determining the data processing result according to the Boolean values.

In some embodiments, the data to be processed comprises measurement data of each of sensors required for a control process, and the processing result is a corresponding control instruction for the control process; or the data to be processed comprises feature data of an object to be recognized required for pattern recognition, and the processing result is a recognition result of the pattern recognition.

According to other embodiments of the present disclosure, there is provided an apparatus for computer learning, comprising: a conversion unit for converting data to be processed into a Boolean vector of which components are Boolean values; a determination unit for, in a set of Boolean functions of a learning model, determining a target Boolean function corresponding to the Boolean vector; a processing unit for using the target processing node to process the Boolean vector to obtain a processing result of the data to be processed.

In some embodiments, the vector to be processed is a Boolean vector of which components are Boolean values, the set of processing nodes is a set of Boolean functions, and the target processing node is a target Boolean function.

In some embodiments, the apparatus for computer learning further comprises a training unit for training the learning model. The training unit is used for creating at least one candidate processing node using the at least one processing node in the set of processing nodes according to at least one training data pair each composed of an input vector and an expected output value, wherein a difference between the processing result of processing the input vector by the candidate processing node and its corresponding expected output value is less than a threshold; according to a restriction function, from the at least one candidate processing node, determining a target processing node corresponding to the input vector.

In some embodiments, the training unit is used for performing operations on the at least one processing node to create the at least one candidate processing node.

In some embodiments, the training unit is used for creating at least one candidate Boolean function using the at least one Boolean function in the set of Boolean functions according to at least one training data pair each comprising an input Boolean vector and an expected output value, wherein a difference between the processing result of processing the input Boolean vector by the candidate processing node and its corresponding expected output value is less than a threshold; according to a restriction function, from the at least one candidate Boolean function, determining a target Boolean function corresponding to the input Boolean vector.

In some embodiments, the training unit is used for performing at least one logical operation on variable assignment conditions of the at least one Boolean function to form a new variable assignment condition, the logical operation comprising at least one of a first logical operation that is a logical operation between different variable assignment conditions, and a second logical operation that is a logical operation between components corresponding to Boolean vectors in different variable assignment conditions; creating the at least one candidate Boolean function according to the new variable assignment condition.

In some embodiments, the restriction function is determined according to the number of logical operations corresponding to the candidate Boolean function; the training unit is used for determining a candidate Boolean function having the minimum number of logical operations as the target Boolean function corresponding to the input Boolean vector.

In some embodiments, there are at least one training data pair comprises a plurality of training data pairs, and the difference between the processing result of processing each input vector by the candidate processing node and its corresponding expected output value is less than a corresponding threshold.

In some embodiments, the training unit is used for adding the at least one candidate processing node to the set of processing nodes.

In some embodiments, the training unit is used for, according to the input Boolean vector in a training data pair, determining the variable assignment condition of a Boolean function; according to the expected output value in the training data pair, determining an evaluation value of the Boolean function.

In some embodiments, the learning model has a plurality of sets of Boolean functions; the determination unit is used for, from the plurality of sets of Boolean functions, determining target Boolean functions corresponding to the Boolean vector, respectively; the processing unit is used for obtaining Boolean values through processing the Boolean vector using the target Boolean functions, respectively; determining the data processing result according to the Boolean values.

In some embodiments, the data to be processed comprises measurement data of each of sensors required for a control process, and the processing result is a corresponding control instruction for the control process; or the data to be processed comprises feature data of an object to be recognized required for pattern recognition, and the processing result is a recognition result of the pattern recognition.

According to still other embodiments of the present disclosure, there is provided an apparatus for computer learning, comprising: a memory; a processor coupled to the memory, the processor configured to, based on instructions stored in the memory, carry out the method for computer learning according to any one of the above embodiments.

According to still further embodiments of the present disclosure, there is provided a non-transitory computer readable storage medium having stored thereon a computer program that, when executed by a processor, implements the method for computer learning according to any one of the above embodiments.

According to further embodiments of the present disclosure, there is provided a control method, comprising: taking measurement data of each of sensors as data to be processed, executing the method for computer learning according to any one of the above embodiments, to obtain a processing result of the measurement data; according to the processing result, determining a control instruction to perform corresponding control processing.

According to further embodiments of the present disclosure, there is provided a recognition method, comprising: taking feature data of an object to be recognized as data to be processed, executing the method for computer learning according to any one of the above embodiments, to obtain a processing result of the feature data; according to the processing result, determining a recognition result of pattern recognition.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 shows a flowchart of some embodiments of a method for computer learning of the present disclosure;

FIG. 2 shows a flowchart of some embodiments of a method for training a machine learning model of the present disclosure;

FIG. 3 shows a flowchart of some embodiments of step 210 in FIG. 2;

FIG. 4 shows a schematic diagram of some embodiments of the method for computer learning of the present disclosure;

FIG. 5 shows a flowchart of other embodiments of the method for computer learning of the present disclosure;

FIG. 6 shows a schematic diagram of still other embodiments of the method for computer learning of the present disclosure;

FIG. 7 shows a block diagram of some embodiments of an apparatus for computer learning of the present disclosure;

FIG. 8 shows a block diagram of other embodiments of the apparatus for computer learning of the present disclosure;

FIG. 9 shows a block diagram of still other embodiments of the apparatus for computer learning of the present disclosure;

FIG. 10 shows a schematic diagram of still other embodiments of the method for computer learning of the present disclosure;

FIG. 11 shows a flowchart of still other embodiments of the method for computer learning of the present disclosure;

FIG. 12 shows a flowchart of some embodiments of a control method of the present disclosure;

FIG. 13 shows a flowchart of some embodiments of a recognition method of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an article is defined in a drawing, there is no need for further discussion in the accompanying drawings.

General computer learning mentioned herein means that, for any task that can be implemented by a computer (according to the Church-Turing thesis, a programmable task), without the need of artificial presupposition or artificial intervention, a computer can automatically learn this task, given that necessary data is provided (and the less the better). Machine learning is a very popular research field at present, but there are no established principles and methods for general computer learning. Moreover, there is no good explanation for what has been achieved.

In response to this situation, research is conducted on general learning. It is found that in order to realize general computer learning, some specific mechanisms must be provided and certain principles must be satisfied. Therefore processing nodes (processing functions) are introduced as a tool, with which some effective theoretical work has been done, for example, it has been proved that a general learning machine does exist.

However, one of the keys to general learning is to establish efficient learning dynamics (learning mechanism). So far, no such learning dynamics has been able to be established. For example, a sufficiently powerful artificial neural network can indeed approximate a function f(x), but the network must be pre-built artificially (according to properties of some data), otherwise, it cannot approximate f(x). Moreover, if the network is a deep network, it is impossible to know exactly what the function f(x) is, that is, it is impossible to know exactly how the function value f(x) is evaluated when the independent variable x is given, or it is impossible to give any clear expression of f(x), and it can only be said that it is in a specific form as a result of the training of the network. Therefore, the network trained in this way cannot be used in other cases. For example, for the learning of 2f(x)+5x², the learning result of f(x) is not helpful at all, and probably needs to be conducted from scratch.

Problems and dilemmas that must be faced comprise: 1) before learning and processing data, a good model must be built artificially; A machine cannot be driven to complete the required learning tasks just by relying on enough data; 2) a completely clear and deterministic understanding of the result generated by the learning cannot be made; 3) the learning result achieved cannot be successfully used in other new fields.

The present disclosure is a set of methods for a learning dynamics. The learning dynamics of the present disclosure is a general mechanism and can be applied to various fields.

In this disclosure, Boolean functions are used frequently, but the principle of the learning dynamics is not limited to Boolean functions, and is also applicable to other learning situations. In the field of computing, any function can be converted into corresponding Boolean functions for processing. The learning dynamics of the present disclosure can be used in various computing fields, such as autonomous driving, aerospace control, power grid management, various pattern recognition (such as pattern recognition for medical diagnosis), robot control, and the like.

In many related arts, a parameter system must be set artificially, and parameters are adjusted to adapt to actual data. The present disclosure adopts a completely different technical principle−establishing a set of systematic methods comprising element processing nodes+expression set+solving for Fitted Extreme Values−to achieve effective machine learning that does not depend on artificial presuppositions.

The inventors of the present disclosure have found the following problems existed in the above-mentioned related art: a parameter system that is set specifically can only be adapted to a specific application scenario, resulting in poor applicability.

In view of this, the present disclosure proposes a technical solution for data processing, which can improve the applicability of data processing.

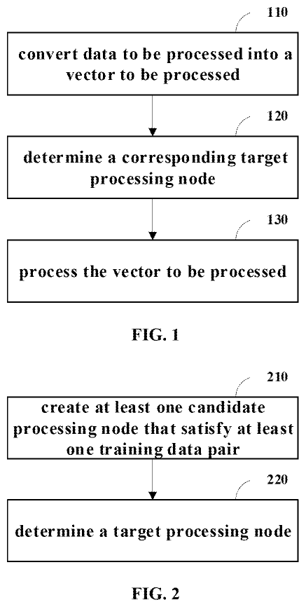

FIG. 1 shows a flowchart of some embodiments of a method for computer learning of the present disclosure.

As shown in FIG. 1, the method comprises: step 110: converting data to be processed into a vector to be processed; step 120: determining a corresponding target processing node; and step 130: processing the vector to be processed.

In step 110, data to be processed is converted into a vector to be processed. For example, the data to be processed is converted into a Boolean vector of which components are Boolean values. For example, the data to be processed may be images, sounds, text, control instructions to be processed. The data to be processed can be converted into a multi-dimensional vector consisting of 1 and 0, that is, a Boolean vector. For example, the Boolean vector after conversion can be a 4-dimensional Boolean vector such as (0,1,0,1), (0,1,1,0), etc.

In step 120, from a set of processing nodes of a learning model, a target processing node corresponding to the vector to be processed is determined. For example, in a set of Boolean functions of a learning model, a target Boolean function corresponding to the Boolean vector is determined. The processing nodes are processing functions, which can be in various forms, such as continuous functions, Boolean functions, and so on.

In some embodiments, the learning model has a set of Boolean functions F={ƒ₁(x), ƒ₂(x) . . . ƒₙ(x) . . . ƒ_{N}(x)}, where N is a positive integer and n is a positive integer less than N. Each Boolean function can be considered as a processing node for processing a Boolean vector in the learning model. The Boolean function ƒₙ(x) is a function with a function value of 1 when the assignment condition of the variable x is satisfied, and a function value of 0 in other cases.

In some embodiments, the Boolean functions in the set of Boolean functions can be created based on training data. For example, the variable assignment condition of the Boolean function is determined according to an input Boolean vector comprised in a training data pair, and the function value of the Boolean function is determined according to the expected output value in the training data pair.

In some embodiments, the training data pair is [x, y], where x is an input Boolean vector and y is an expected output value. For example, if three training data pairs [(0,1,0,1), 1], [(1,1,0,1), 0], [(0,0,1,0), 0] have been produced, three Boolean functions ƒ₁(x), ƒ₂(x), ƒ₃(x) in the set of Boolean functions can be created from these three training data pairs:

$${f}_{1} ( x ) = \{ \begin{matrix}1 & x = {x}_{1} \\ 0 & x \neq {x}_{1}\end{matrix} ; \\ {f}_{2} ( x ) = \{ \begin{matrix}1 & x = {x}_{2} \\ 0 & x \neq {x}_{2}\end{matrix} ; \\ {f}_{3} ( x ) = \{ \begin{matrix}1 & x = {x}_{3} \\ 0 & x \neq {x}_{3}\end{matrix}$$

x₁=(0,1,0,1), x₂=(1,1,0,1), x₃=(0,0,1,0), and the corresponding expected output values are y₁=1, y₂=0, y₃=0, respectively. The variable assignment conditions of ƒ₁(x), ƒ₂(x), ƒ₃(x) are C₁: x=x₁, C₂: x=x₂, C₃: x=x₃, respectively. Such Boolean functions created directly from at least one training data pair can be considered as element processing nodes (or element Boolean functions) of an expanded set of Boolean functions. For example, in the process of use, if the Boolean vector converted from the data to be processed is (0,1,0,1),the target Boolean function can be determined to be ƒ₁(x).

In some embodiments, whether to expand corresponding element Boolean functions may be determined according to experience or the frequency of occurrence of Boolean vectors. For example, the element Boolean function of a Boolean vector of which frequency of occurrence exceeds a frequency threshold will be expanded.

In some embodiments, logical operations may be performed on the variable assignment conditions of the Boolean functions to form new variable assignment conditions. For example, the logical operation comprises at least one of a first logical operation and a second logical operation. The first logical operation is a logical operation between different variable assignment conditions, and a second logical operation is a logical operation between components corresponding to Boolean vectors in different variable assignment conditions. At least one candidate Boolean function can be created according to the new variable assignment conditions.

For example, logical operations can be performed on variable assignment conditions c₁, c₂, and c₃ to obtain new variable assignment conditions:

c₄=c₁·c₃: x=x₄;

c₅=c₁·c₂·c₃: x=x₅;

c₆=c₁+c₅=c₁+c₁·c₂·c₃: x=x₁ or x₅;

c₇=c₁+c₄=c₁+c₁·c₃: x=x₁ or x₄

“+” represents a first logical operation, that is, to fulfill one of the conditions before and after “+” satisfied, and “or” is a logic “or” operation. “·” represents a second logical operation to perform a logic “or” operation on the components corresponding to the Boolean vectors in the conditions before and after “·”.

For example, x₄ is a logical “or” operation of the components corresponding to the Boolean vectors x₁ and x₃ in c₁ and c₃, x₄=(0,1,1,1). In this case, a Boolean function created based on the new variable value condition c₄ is:

$${f}_{4} ( x ) = \{ \begin{matrix}1 & x = {x}_{4} \\ 0 & x \neq {x}_{4}\end{matrix}$$

Similarly, x₅=(1,1,1,1) can be obtained, and a Boolean function ƒ₅(x) can be created according to the corresponding variable assignment condition c₅.

For example, c₆ is c₁ or c₅, in this case, a boolean function created according to the new variable assignment condition c₆ is:

$${f}_{6} ( x ) = \{ \begin{matrix}1 & x = {x}_{1} or {x}_{5} \\ 0 & x \neq {x}_{1} , x \neq {x}_{5}\end{matrix}$$

Similarly, a Boolean function ƒ₇(x) can be created according to c₇.

In this way, new processing nodes can be created by performing logical operations on the element processing nodes, and these new processing nodes can be regarded as expanded processing nodes (or expanded Boolean functions) of the learning model, thereby improving the data processing capability of the learning model.

In some embodiments, the data to be processed may be converted into a real vector of which components are real values; from a set of real functions of a learning model, a target real function corresponding to the real vector is determined; the real vector is processed using the target real function to obtain a processing result of the data to be processed.

In step 130, the vector to be processed is processed using the target processing node to obtain a processing result of the data to be processed. For example, the Boolean vector is processed using the target Boolean function to obtain a processing result of the data to be processed. For example, the Boolean vector (0,1,0,1) is processed using the target Boolean function ƒ₁(x), and the obtained processing result is a Boolean value 1.

In some embodiments, the data to be processed is transformed into several Boolean vectors, which can cause some Boolean functions called element processing nodes to be generated. Element processing nodes are basic elements of learning. These element processing nodes are then used to generate a set of Boolean functions of the learning model, from which a target Boolean function corresponding to the Boolean vector is determined; The Boolean vector is processed using the target Boolean function to obtain a processing result of the data to be processed.

In some embodiments, the target Boolean function corresponding to the Boolean vector may be determined by training a learning model. For example, this can be implemented as illustrated in the embodiment of FIG. 2.

FIG. 2 shows a flowchart of some embodiments of a method for training a machine learning model of the present disclosure.

As shown in FIG. 2, this method comprises: step 210: creating at least one candidate processing node that satisfy at least one training data pair; and step 220: determining a target processing node.

In step 210, at least one candidate processing node are created using processing nodes in a set of processing nodes according to a training data pair. For example, according to the training data pair, at least one candidate Boolean function are created using Boolean functions in a set of Boolean functions. The training data pair comprises an input Boolean vector and an expected output value, wherein a difference between the processing result of processing the input Boolean vector by a candidate processing node and the expected output value is less than a threshold.

In some embodiments, the at least one training data pair comprises a plurality of training data pairs, and the difference between the processing result of processing each input vector by the candidate processing node and its corresponding expected output value is less than a corresponding threshold. For example, for 3 training data pairs [x1, y1], [x2, y2], [x3, y3], it is necessary to find a Boolean function ƒ(x) in the set of Boolean functions that satisfies the following objective functions:

|ƒ(x₁)−y₁|<∈₁

|ƒ(x₂)−y₂|<∈₂

|ƒ(x₃)−y₃|<∈₃

ε₁, ε₂ and ε₃ are positive constants that are small enough, and can be the same or different.

In some embodiments, a Boolean function that can satisfy the above formulas can be found in the set of Boolean functions as a candidate Boolean function. For example, in conjunction with the above embodiment, at least one candidate Boolean function may comprise ƒ₁(x), ƒ₆(x), and ƒ₇(x).

In step 220, according to a restriction function, a target processing node corresponding to the input vector is determined from the at least one candidate processing node. For example, a target Boolean function corresponding to the input Boolean vector is determined from the at least one candidate Boolean function.

In some embodiments, a restriction function of the target function can be set to determine the target Boolean function. For example, a candidate Boolean function that performs the minimum number of logical operations on the element Boolean functions among the at least one candidate Boolean function is used as the target Boolean function.

In some embodiments, ƒ₁(x) does not perform any logical operations, ƒ₆(x) performs three logical operations (one “+”, two “·”), and ƒ₇(x) performs two logical operations (one “+”, one “·”). Therefore, ƒ₁(x) is determined as the target Boolean function.

In some embodiments, there is no Boolean function in the set of Boolean functions that can satisfy the at least one training data pair. In this case, at least one candidate processing node can be created by performing operations on the processing nodes. For example, operations may comprise combination or arithmetic (such as addition and subtraction)operations on the processing functions.

In some embodiments, step 210 may be implemented as illustrated in the embodiment shown in FIG. 3.

FIG. 3 shows a flowchart of some embodiments of step 210 in FIG. 2.

As shown in FIG. 3, step 210 comprises: step 2110: forming variable assignment conditions through logical operations; and step 2120: creating at least one candidate Boolean function.

In step 2110, logical operations may be performed on the variable assignment conditions of the existing Boolean functions to form new variable assignment conditions.

In step 2120, according to the new variable assignment conditions, at least one candidate Boolean function that can meet the requirements of the at least one training data pair are created. For example, a candidate Boolean function having the minimum number of logical operations can be determined as the target Boolean function corresponding to the input Boolean vectors.

In some embodiments, the target Boolean function needs to satisfy: if the input Boolean vectors in the at least one training data pair are (0,1,0,1), (0,1,1,0), (1,1,0,0), (1,0,1,0), (1,0,0,1), (0,0,1,1), (0,0,0,0), the expected output value is 1; if the input Boolean vectors are (1,0,0,0), (0,1,0,0), (0,0,1,0), (0,0,0,1), (1,1,1,0), (0,1,1,1), (1,0,1,1), (1,1,0,1), (1,1,1,1), the expected output value is 0. There is no Boolean function in the set of Boolean functions that can satisfy these at least one training data pair.

In this case, at least one candidate Boolean function that satisfy the condition can be created by performing logical operations on the existing Boolean functions. One of the at least one candidate Boolean function that has the minimum number of logical operations is selected as the target Boolean function.

In some embodiments, element Boolean functions in the set of Boolean functions may also be adjusted by further inputting new training data pair. For example, on the basis of the set of Boolean functions in the above embodiment, at least one training data pair (such as [(1,1,0,0), 1], [(0,1,1,0), 1], and [(0,0,1,1), 1]) can be further inputted for training.

On this basis, the variable assignment conditions of the element Boolean functions in the set of Boolean functions are adjusted to d₁: x=(1,0,0,0), d₂: x=(0,1,0,0) , d₃: x=(0,0,1,0), d₄: x=(0,0,0,1). Logical operations can be performed on these element Boolean functions to generate a new variable assignment condition:

d₅=d₁·d₂+d₁·d₃+d₁·d₄+d₂·d₃+d₂·d₄+d₃·d₄

A Boolean function e₅(x) created according to d₅ can meet the requirements of the above at least one training data pair, so e₅(x) is used as the target Boolean function for processing the input Boolean vectors in the above at least one training data pair.

In some embodiments, the created candidate Boolean function may be added to the set of Boolean functions to improve the learning ability of the learning model.

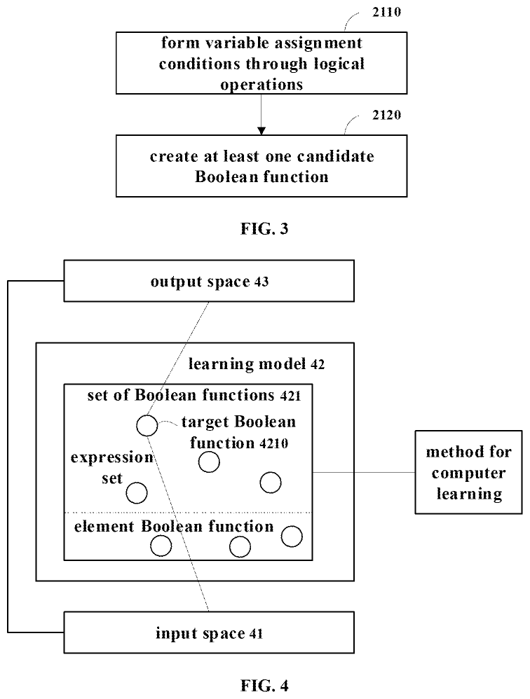

FIG. 4 shows a schematic diagram of some embodiments of the method for computer learning of the present disclosure.

As shown in FIG. 4, an input space 41 may be an M-bit binary vector space, where M is an integer greater than 1. The input space 41 receives M-dimensional input information converted from data to be processed, and sends it to a target Boolean function 4210 in a set of Boolean functions 421 in a learning model 42 for processing (or sends it to another Boolean function). If the input space 41 receives a training data pair, an expected output value is sent to an output space 43 for learning.

The output space 43 is a K-bit binary vector space, where K is an integer greater than or equal to 1. The output space 43 receives a K-dimensional output value of the target Boolean function 4210 and outputs the output value according to its internal logic.

The core part of the learning model 42 is the set of Boolean functions 421. The set of Boolean functions 421 comprises a plurality of processing nodes, that is, Boolean functions (circles in the figure). These processing nodes comprise element processing nodes and expanded processing nodes that are created through logical operations based on the element processing nodes. All the processing nodes constitute a vector representation space.

The set of Boolean functions 421 may contain element Boolean functions and an expression set. Boolean functions in the expression set are Boolean functions obtained through expanding the element Boolean functions through logical operations.

The learning model 42 performs data processing and training through the computer learning method of any of the above embodiments.

In some embodiments, when a multi-dimensional Boolean vector needs to be output as a processing result, the components in the multi-dimensional Boolean vector can be set to the expected output values of the input Boolean vectors; multiple target functions are set to determine at least one candidate Boolean function that can meet the relationship between the input Boolean vectors and the expected outputs; multiple target Boolean functions are determined from the at least one candidate Boolean function according to a restriction constraint.

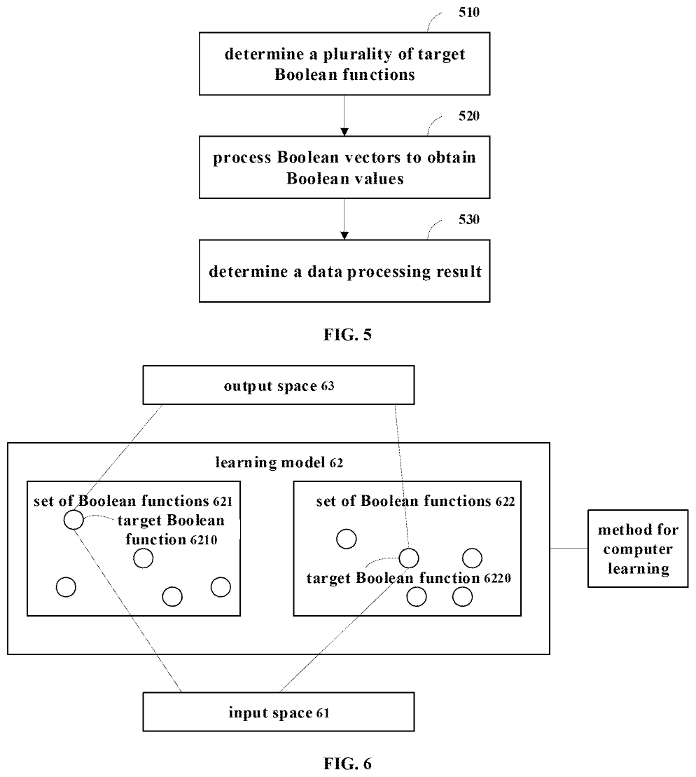

In some embodiments, a plurality of sets of Boolean functions can be configured in the learning model to output a multi-dimensional Boolean vector as a processing result. For example, this can be implemented as illustrated in the embodiment of FIG. 5.

FIG. 5 shows a flowchart of other embodiments of the method for computer learning of the present disclosure.

As shown in FIG. 5, different from the embodiment in FIG. 1, this method may further comprises: step 510: determining a plurality of target Boolean functions; step 520: processing Boolean vectors to obtain Boolean values; and step 530, determining a data processing result.

In step 510, target Boolean functions corresponding to the Boolean vectors are determined from a plurality of sets of Boolean functions, respectively.

In step 520, Boolean values are obtained through processing the Boolean vectors using the target Boolean functions, respectively.

In step 530, a data processing result is determined according to the Boolean values.

For example, the outputting of a multi-dimensional Boolean vector may be implemented as illustrated in the embodiment of FIG. 6.

FIG. 6 shows a schematic diagram of still other embodiments of the method for computer learning of the present disclosure.

As shown in FIG. 6, a learning model 62 has two sets of Boolean functions 621 and 622. An input space 61 inputs Boolean vectors into the learning model 62, and determines a target Boolean function 6210 in the set of Boolean functions 621 and a target Boolean function 6220 in the set of Boolean functions 622 according to the computer learning method.

The learning model 62 processes the Boolean vectors using the target Boolean function 6210 and the target Boolean function 6220 to obtain corresponding Boolean values respectively, and outputs the Boolean values to the output space 63. The output space 63 concatenates the two Boolean values into one output vector as a processing result of the Boolean vectors.

The method can perform classification, regression and other processing on data such as images, sounds, text, and control instructions, and output corresponding recognition results, response results, and the like.

In the above embodiment, a vector representation space with high applicability is constructed by using a set of Boolean functions, which can be used to process various Boolean vectors converted from data to be processed, thereby improving the applicability of data processing.

FIG. 7 shows a block diagram of some embodiments of an apparatus for computer learning of the present disclosure.

As shown in FIG. 7, the apparatus for computer learning comprises a conversion unit 71, a determination unit 72, and a processing unit 73.

The conversion unit 71 is used for converting data to be processed into a vector to be processed. For example, the data to be processed is converted into a Boolean vector of which components are Boolean values. The determination unit 72 is used for, from a set of processing nodes of a learning model, determining a target processing node corresponding to the vector to be processed. For example, from a set of Boolean functions of a learning model, a target Boolean function corresponding to the Boolean vector is determined. The processing unit 73 is used for processing the vector to be processed using the target processing node to obtain a processing result of the data to be processed. For example, the Boolean vector is processed using the target Boolean function to obtain a processing result of the data to be processed.

In some embodiments, the learning model is trained by: according to at least one training data pair, creating at least one candidate Boolean function using Boolean functions in a set of Boolean functions. The training data pair comprises an input Boolean vector and an expected output value, wherein a difference between the processing result of processing the input Boolean vector by a candidate Boolean function and the expected output value is less than a threshold. For example, the processing unit 73 may add the at least one candidate Boolean function to the set of Boolean functions.

For example, logical operations may be performed on the variable assignment conditions of the Boolean functions to form new variable assignment conditions. The logical operation comprises at least one of a first logical operation and a second logical operation. The first logical operation is a logical operation between different variable assignment conditions, and a second logical operation is a logical operation between components corresponding to Boolean vectors in different variable assignment conditions. At least one candidate Boolean function can be created according to the new variable assignment conditions.

In some embodiments, a target Boolean function corresponding to the input Boolean vector is determined from the at least one candidate Boolean function. For example, a candidate Boolean function having the minimum number of logical operations can be determined as the target Boolean function corresponding to the input Boolean vectors.

In some embodiments, there are at least one training data pair comprises a plurality of training data pairs, and the difference between the processing result of processing each input vector by the candidate processing node and its corresponding expected output value is less than a corresponding threshold.

In some embodiments, according to the input Boolean vector in a training data pair, the variable assignment condition of a Boolean function is determined; according to the expected output value in the training data pair, an evaluation value of the Boolean function is determined.

In some embodiments, the learning model has a plurality of sets of Boolean functions. The determination unit 72 is used for, from the plurality of sets of Boolean functions, determining target Boolean functions corresponding to the Boolean vector, respectively. The processing unit 73 is used for obtaining Boolean values through processing the Boolean vector using the target Boolean functions, respectively. The determining unit 72 is used for determining a data processing result according to the Boolean values.

In the above embodiment, a vector representation space with high applicability is constructed by using a set of Boolean functions, which can be used to process various Boolean vectors converted from data to be processed, thereby improving the applicability of data processing.

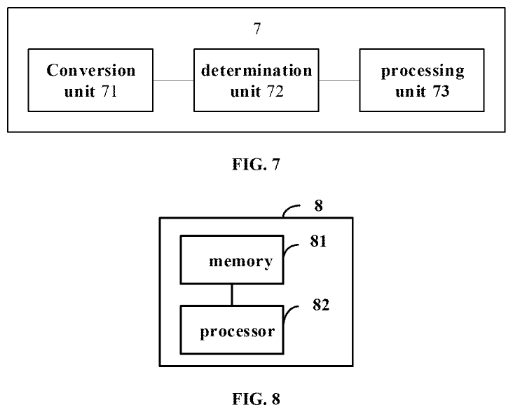

FIG. 8 shows a block diagram of other embodiments of the apparatus for computer learning of the present disclosure.

As shown in FIG. 8, the computer learning apparatus 8 of this embodiment comprises: memory 81 and a processor 82 coupled to the memory 81, the processor 82 configured to, based on instructions stored in the memory 81, carry out the method for computer learning according to any one of the embodiments.

Wherein, the memory 81 may comprise, for example, system memory, a fixed non-volatile storage medium, or the like. The system memory stores, for example, an operating system, applications, a boot loader, a database, and other programs.

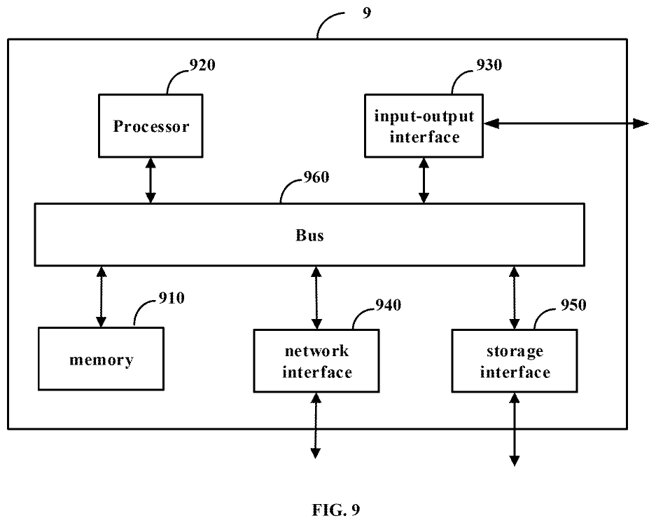

FIG. 9 shows a block diagram of still other embodiments of the apparatus for computer learning of the present disclosure.

As shown in FIG. 9, the computer learning apparatus 9 of this embodiment comprises: memory 910 and a processor 920 coupled to the memory 910, the processor 920 configured to, based on instructions stored in the memory 910, carry out the method for computer learning according to any one of the embodiments.

The memory 910 may comprise, for example, system memory, a fixed non-volatile storage medium, or the like. The system memory stores, for example, an operating system, application programs, a boot loader (Boot Loader), and other programs.

The computer learning apparatus 9 may further comprise an input-output interface 930, a network interface 940, a storage interface 950, and the like. These interfaces 930, 940, 950 and the memory 910 and the processor 920 may be connected to each other through a bus 960, for example. Wherein, the input-output interface 930 provides a connection interface for input-output devices such as a display, a mouse, a keyboard, and a touch screen. The network interface 940 provides a connection interface for various networked devices. The storage interface 950 provides a connection interface for external storage devices such as an SD card and a USB flash disk.

The technical solution of the present disclosure can be clearly illustrated through the following embodiments.

In some embodiments, the method of the present disclosure may be used to implement a learning machine.

For example, the basic structure of the learning machine can be seen in FIG. 4. The most basic components of the learning machine are: input space 41, output space 42, a mind space (learning machine model 42) and a restraint space (a method for computer learning).

The input space 41 may be an N-bit binary vector space. The input space receives input information (N-bit), and then sends the information to a current processing node (a target Boolean function 4210) in the mind space. It may also be sent to other processing nodes (other Boolean functions). The input space 41 may also receive information for training. When there is available information for training, the input space 41 sends the information to the output space 42.

The output space 43 may be an M-bit binary vector space. The output space 43 receives the output value (M-bit) of the current processing node, and outputs this value (according to its internal logic). The output space also receives training data from the input space for learning.

The mind space is the core of the learning machine. Mathematical objects that are referred to as processing nodes herein are comprised in the mind space. These nodes are units used to process information. Some of the processing nodes, called as element processing nodes, are basic processing nodes, and the other processing nodes are constructed by manipulating the element processing nodes.

Suppose that all the element processing nodes in the mind space are: g1, g2 . . . gL, where L is a positive integer. The mind space adopts these element processing nodes to build more processing nodes. All these constructed processing nodes form an expression set.

A processing node is selected in the expression set as the current processing node, that is, this processing node is a current information processor that implements, from input to output, information processing in the learning machine.

There are basic control programs and associated data in the restraint space for controlling the learning machine and carrying out the learning dynamics. The role of the restraint space and the mind space are theoretically demonstrated. As shown in FIG. 4, the restraint space will restrain various learning activities in the mind space. According to this theoretical guidance, the restraint space is designed and arranged for the learning machine.

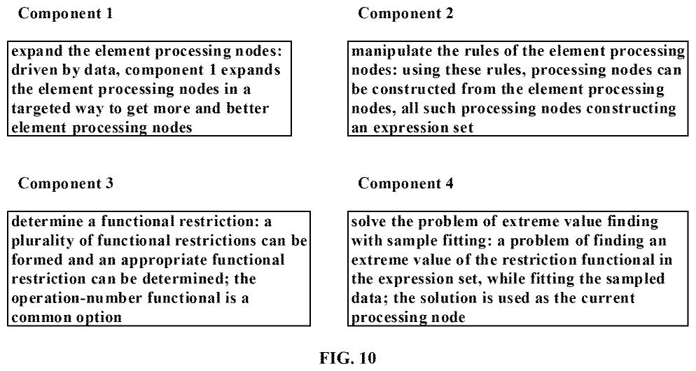

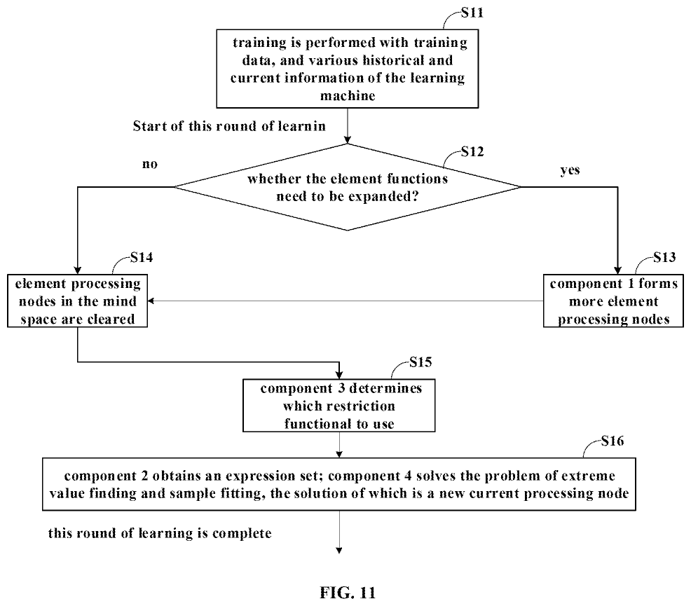

FIG. 10 shows a schematic diagram of still other embodiments of the method for computer learning of the present disclosure.

As shown in FIG. 10, components 1 to 4 are installed in the restraint space. In many cases, the learning machine is only a sing1e-level learning machine, and therefore the restraint space is substantially unchanged. However, if the learning machine is a multi-level learning machine, the restraint space itself is also a learning machine, and some variations and adaptations can be made (the restraint space has its own learning machine, having a mind space and a restraint space at a higher level according1y).

Regarding the operation of the learning machine, there are basically two operating states of the learning machine, i.e., training and working, as shown in FIG. 4. The difference between the two states is only whether there is training data to be added to the output space. The learning machine obtains data from the input space. If the output value for training in the data is not empty, the learning machine uses this value to perform a training process. If this value is empty, the learning machine will only use the current processing node to process information and then output. Therefore, the learning machine can be easily used for online learning, and the trained learning machine can also be easily used in practice.

FIG. 10 illustrates basic components of the learning dynamics. There are four most important components, which will be explained below.

Component 1 expands the element processing nodes: driven by data, component 1 expands the element processing nodes in a targeted way to get more and better element processing nodes. As shown in FIG. 4, element processing nodes are some special processing nodes, based on which, more processing nodes can be constructed following some operation rules. Therefore, they play an important role. Effective learning cannot be carried out without proper element processing nodes. However, element processing nodes can be expanded, especially driven by data, in a targeted way, so that more and better element processing nodes can be supplemented. In this way, learning can be effective.

Component 2 manipulates the rules of the element processing nodes: using these rules, processing nodes can be constructed from the element processing nodes, all such processing nodes constructing an expression set. Suppose that all the element processing nodes in the mind space are in the form of: g1, g2 . . . gL, from these element processing nodes, operations can be carried out to get more processing nodes. For example, the set K is expressed as follows:

K={f|f=c(g1, g2, . . . , gL)}

Here, g1, g2 . . . gL are the element processing nodes and c is some operation. This set K is the expression set. The current processing node is selected from K.

Component 3 determines a functional restriction: a plurality of functional restrictions can be formed and an appropriate functional restriction can be determined. The functional restriction J is a functional defined on the expression set K, namely: J: K→R, where R is the field of real number. J may be in the form of: J(f)=|f−f₀|.

Component 3 will establish more restriction functions in the learning process, and select an appropriate restriction function for later use. This is an important part of the learning dynamics. The operation-number functional is a common option. However, in many cases, other more suitable restriction functionals should be chosen.

Component 4 solves the problem of extreme value finding with sample fitting: a problem of finding an extreme value of the restriction functional in the expression set, while fitting the sampled data. Assuming that the expression set is K, the restriction functional is J, and the data given for training are: (x₁, y₁), (x₂, y₂), . . . (xₚ, yₚ), P is a positive integer, the following extreme value problem is called as the restriction functional extreme value problem under the condition of data fitting, or simply called extreme value finding with sample fitting:

Min: J(f), f ϵ K&|f(xᵢ)−yᵢ|<∈, i=1,2, . . . , P

That is, the problem of extreme value finding with sample fitting is to find such f: f is in the expression set, and meets the data condition on the training data (i.e., fitting), and makes the restriction functional take a minimum value.

If function \dot{f} is the solution of the extreme value problem described above, it is used as the new current processing node (such as the target Boolean function).

Applying these components, the basic logic of learning dynamics is shown in FIG. 11.

FIG. 11 shows a flowchart of still other embodiments of the method for computer learning of the present disclosure.

As shown in FIG. 11, in step S11, training is performed with training data, and various historical and current information of the learning machine.

In step S12, it is determined whether the element functions need to be expanded. If yes, step S13 is executed; otherwise, step S14 is executed.

In step S13, component 1 is used to form more element processing nodes.

In step S14, element processing nodes in the mind space are cleared.

In step S15, component 3 is used to decide which restriction functional to use.

In step S16, component 2 is used to obtain an expression set. Component 4 is used to solve the problem of extreme value finding and sample fitting, the solution of which is a new current processing node. This round of learning is then complete.

The four components described above are applied in the learning dynamics. Component 1 is applied if new element processing nodes need to be expanded. After cleaning up the element processing nodes, it proceeds to the step of determine a restriction functional to be used. Here, component 3 will be applied and is a key for successful learning of this learning machine. Then, the learning process focuses on the problem of extreme value finding and sample fitting. Here, component 2 and component 4 will be applied.

It is emphasized here that the learning dynamics above are accomplished by selecting the restriction functional and expanding the element processing nodes, thereby forming a completely new learning method that is completely different from the usual machine learning. This is the core of the present disclosure. In this way, learning can be driven with as little data as possible. Driven by enough data (not big data, but just enough data), it is completely possible to accurately learn the laws contained in the data. This is the learning dynamics of general learning machine: using as little data as possible to reach as precise and deterministic conclusions as possible. This is an innovation of the present disclosure. To the best of knowledge, no learning technique currently comes close to this idea.

The innovation of the present disclosure is: taking the learning machine one step further, it has been proven that such a learning machine is universal, i.e. it can learn any pattern. The present disclosure further improved the design of the learning machine, and explicitly proposed the mind space and the restraint space.

The present disclosure provides the specific structure of the mind space: element processing nodes, an expression set, and a current processing node. These are inevitable in future development of artificial intelligence.

The present disclosure provides the learning dynamics of a general learning machine. It has been theoretically proven that it is indeed possible to make a general learning machine. This is a very significant innovation.

In short, the learning machine in the present disclosure is a machine that has the initiative to learn and adjust itself, while other learning methods and function approximation methods are only parameter systems built artificially, which can only adapt to data through parameter adjustment, and are thereby passive learning machines. This is the fundamental difference, and is the significant innovation of the present disclosure.

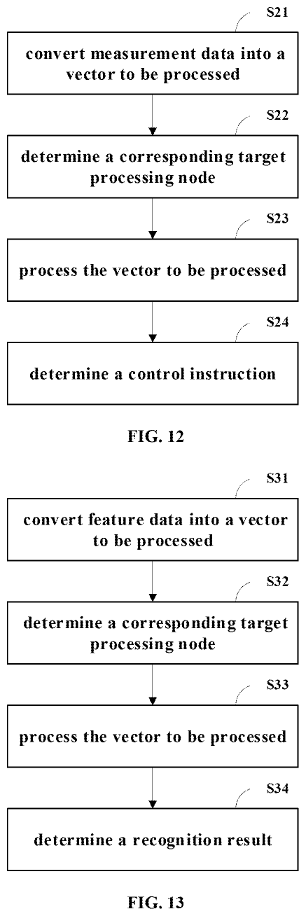

FIG. 12 shows a flowchart of some embodiments of a control method of the present disclosure.

As shown in FIG. 12, this control method comprises: step S21: converting measurement data into a vector to be processed; step S22: determining a corresponding target processing node; step S23: processing the vector to be processed; step S24: determining a control instruction.

In step S21, measurement data of sensors is converted into a vector to be processed.

In step S22, from a set of processing nodes of a learning model, a target processing node corresponding to the vector to be processed is determined.

In step S23, the vector to be processed is processed using the target processing node to obtain a processing result of the measurement data.

In step S24, according to the processing result, a control instruction is controlled to perform corresponding control processing.

FIG. 13 shows a flowchart of some embodiments of a recognition method of the present disclosure.

As shown in FIG. 13, this recognition method comprises: step S31: converting feature data into a vector to be processed; step S32: determining a corresponding target processing node; step S33: processing the vector to be processed; and step S34, determining a recognition result.

In step S31, feature data of an object to be recognized is converted into a vector to be processed.

In step S32, from a set of processing nodes of a learning model, a target processing node corresponding to the vector to be processed is determined.

In step S33, the vector to be processed is processed using the target processing node to obtain a processing result of the measurement data.

In step S34, according to the processing result, a recognition result of pattern recognition is determined.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

So far, the method for computer learning, the apparatus for computer learning, and the computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which comprise machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. A method for computer learning, comprising:
converting data to be processed into a vector to be processed;
determining a target processing node corresponding to the vector to be processed from a set of processing nodes of a learning model; and
obtaining a processing result of the data to be processed by using the target processing node to process the vector to be processed.

2. The method for computer learning according to claim 1, wherein the vector to be processed is a Boolean vector, of which components are Boolean values, the set of processing nodes is a set of Boolean functions, and the target processing node is a target Boolean function.

3. The method for computer learning according to claim 1, wherein the learning model is trained by:
creating at least one candidate processing node using at least one processing node in the set of processing nodes according to at least one training data pair, each of the at least one training data pair comprising an input vector and an expected output value, wherein a difference between a processing result of processing the input vector by each of the at least one candidate processing node and the expected output value is less than a threshold; and
determining a target processing node corresponding to the input vector, according to a restriction function, from the at least one candidate processing node.

4. The method for computer learning according to claim 3, wherein creating at least one candidate processing node using at least one processing node in the set of processing nodes comprises:
creating the at least one candidate processing node, by performing operations on the at least one processing node.

5. The method for computer learning according to claim 2, wherein the learning model is trained by:
creating at least one candidate Boolean function using at least one Boolean function in the set of Boolean functions according to at least one training data pair, each of at least one training data pair comprising an input Boolean vector and an expected output value, wherein a difference between a processing result of processing the input Boolean vector by each of the at least one candidate processing node and the expected output value is less than a threshold; and
determining a target Boolean function corresponding to the input Boolean vector from the at least one candidate Boolean function, according to a restriction function.

6. The method for computer learning according to claim 5, wherein creating at least one candidate Boolean function using at least one Boolean function in the set of Boolean functions comprises:
performing at least one logical operation on variable assignment conditions of the at least one Boolean function to form a new variable assignment condition, the at least one logical operation comprising at least one of a first logical operation between different variable assignment conditions or a second logical operation between components corresponding to Boolean vectors in different variable assignment conditions; and
creating the at least one candidate Boolean function according to the new variable assignment condition.

7. The method for computer learning according to claim 6, wherein the restriction function is determined according to a number of the at least one logical operation corresponding to the at least one candidate Boolean function, and
determining a target Boolean function corresponding to the input Boolean vector from the at least one candidate Boolean function comprises:
determining a candidate Boolean function having the minimum number of logical operations as the target Boolean function corresponding to the input Boolean vector.

8. The method for computer learning according to claim 3, wherein the at least one training data pair comprises a plurality of training data pairs, and a difference between the processing result of processing each input vector of the at least one training data pair by each of the at least one candidate processing node and each expected output value of the at least one training data pair is less than a corresponding threshold.

9. The method for computer learning according to claim 3, further comprising:
adding the at least one candidate processing node to the set of processing nodes.

10. The method for computer learning according to claim 2, wherein a Boolean function in the set of Boolean functions is created by:
determining a variable assignment condition of the Boolean function, according to an input Boolean vector in a training data pair; and
determining a value of the Boolean function, according to an expected output value in the training data pair.

11. The method for computer learning according to claim 2, wherein:
the learning model has a plurality of sets of Boolean functions;
target Boolean functions corresponding to the Boolean vector from the plurality of sets of Boolean functions are determined, respectively;
Boolean values through processing the Boolean vector using the target Boolean functions are obtained, respectively;
the data processing result according to the Boolean values is determined.

12. The method for computer learning according to claim 1, wherein:
the data to be processed comprises measurement data of each of sensors required for a control process, and the processing result is a corresponding control instruction for the control process; or
the data to be processed comprises feature data of an object to be recognized required for pattern recognition, and the processing result is a recognition result of the pattern recognition.

13. (canceled)

14. An apparatus for computer learning, comprising:
a memory; and
a processor coupled to the memory, the processor configured to, based on instructions stored in the memory, carry out the method for computer learning according to claim 1.

15. A non-transitory computer-readable storage medium on which a computer program is stored, which when executed by a processor implements the method for computer learning according to claim 1.

16. A control method, comprising:
taking measurement data of each of sensors as data to be processed, executing the method for computer learning according to claim 1, to obtain a processing result of the measurement data; and
determining a control instruction to perform control processing corresponding to the control instruction, according to the processing result.

17. A recognition method, comprising:
taking feature data of an object to be recognized as data to be processed, executing the method for computer learning according to claim 1, to obtain a processing result of the feature data; and
determining a recognition result of pattern recognition, according to the processing result.
